(19) United States
(12) Patent Application Publication
(10) Pub. No.: US 2010/0256791 A1
(43) Pub. Date: Oct. 7, 2010

(54) METHOD AND APPARATUS FOR THE THREE-DIMENSIONAL SHAPE MAGNETIC FORMING OF A MOTOR CORE

(75) Inventors: John Patrick Spicer, Plymouth, MI (US); Jeffrey A. Abell, Rochester Hills, MI (US); Paul E. Krajewski, Troy, MI (US); John C. Ulicny, Oxford, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/699,202

(22) Filed: Feb. 3, 2010

Related U.S. Application Data
(60) Provisional application No. 61/166,954, filed on Apr. 6, 2009.

(51) Int. Cl. G06F 19/00

(52) U.S. Cl. 700/98; 345/420

(57) ABSTRACT

A method of forming a cylindrical magnetic motor core having predetermined magnetic properties includes recording a 3D geometrical model, translating the geometry of the model into control parameters, and positioning magnetic material within a staging area surrounded by independently-controllable magnetic field generators. The control parameters are transmitted to the field generators to generate 3D magnetic fields, which are controlled to magnetically shape the material into a motor core substantially conforming to the model. After shaping, the core may be solidified to form a finished core. A system for forming the magnetic motor core includes a host computer controlling the position and motion of each field generator. The 3D model is used by the host computer to control the magnetic field generators and shape the MR material into the magnetic motor core.

### CROSS REFERENCE TO RELATED APPLICATION

This application claims priority to and the benefit of U.S. Provisional Patent Application No. 61/166,954, filed Apr. 6, 2009, and which is hereby incorporated by reference in its entirety.

### TECHNICAL FIELD

The invention relates to a method and apparatus for forming magnetic motor cores.

### BACKGROUND OF THE INVENTION

Magnetorheological (MR) fluids include magnetic or easily magnetized particles, e.g., iron or an oxide thereof, that are intermixed with or suspended within a suitable viscous carrier material, typically a fluid such as oil, a solvent, water, and/or another suitable carrier. The particles may comprise approximately 30 to 90 percent of the total weight of the volume of MR material, although other percentages may be used depending on the particular application. Surfactants may be combined with the carrier for added protection of the suspended particles, and for further optimization of particle suspension within the carrier.

When an MR material is exposed to a magnetic field, the yield stress of the MR material rapidly increases by several orders of magnitude. The yield stress increase is due to the formation of orderly columns of magnetic particles within a volume or across a gap containing the MR material, with the alignment of the columns being in the flux direction of the applied magnetic field. This change in yield stress is readily and quickly reversible by reducing or terminating the magnetic field. Since the magnetic field of an electromagnet can be controlled via control of the electrical current delivered from an energy supply, the viscosity and yield stress can be precisely controlled to provide a host of potentially useful applications, for example MR fluid clutches, couplings, body armor, etc.

A magnetic dipole moment induced on the suspended particles when the MR material subjected to the magnetic field will ultimately form a complex chain-like structure, i.e., the structure which forms the orderly particle columns described above. If the same magnetic suspension is exposed to a biaxial magnetic field, the induced dipole moments can be used to align the particles in a more complex two-dimensional orientation. However, while the physical properties of the MR materials subjected to such magnetic fields can be used for torque-transmission and to temporarily change the apparent viscosity of an MR fluid for a particular purpose as noted above, conventional methods may remain less than optimal for certain manufacturing purposes.

### SUMMARY OF THE INVENTION

Accordingly, a method is provided for fabricating or magnetically shape-forming a finished magnetic core for an electric motor, the core having a predetermined particle distribution. The core may be formed with a minimal amount of tooling to a complex or three-dimensional (3D) finished geometrical shape. The method includes shaping a volume of MR material having a mixture of micron-sized as well as nano-sized particles.

To form a complex shape, i.e., a cylindrical shape of a stator or rotor core, overlapping or superimposed 3D magnetic fields are generated and precisely controlled with respect to the volume of MR material. Likewise, the method can be used to tailor or tune the magnetic properties of the motor core, which in one embodiment may be partially or substantially pre-formed using a press or other minimal tooling, and then precisely shaped and/or tuned via the controlled application of superimposed 3D magnetic fields. The finished core has the desired complex or 3D geometry, which can be rendered precisely and in a highly repeatable manner.

After shaping, and while held present within the flux paths of the superimposed 3D magnetic fields, the shaped component is subjected to a suitable curing and/or solidification process to permanently fix the desired 3D geometry, for example using a 2-part epoxy curing process, and/or heat curing, laser sintering, ultraviolet curing, chemical curing, and/or any other suitable curing method. The method may be used for both static and dynamic control of the complex geometry of the core, as well as its desired magnetic particle distribution and associated magnetic properties.

In particular, a method of forming a finished motor core may include recording a predetermined 3D geometrical model in a memory location accessible by a host computer, and using the host computer and the 3D geometrical model to derive or calculate a solution to an inverse electromagnetic shaping problem translating the complex geometry of the model into a set of control parameters. A predetermined volume of MR material positioned within a staging area is surrounded by an array of independently-controllable magnetic field generators, such as a set of electromagnets and/or permanent magnets. The control parameters and any required energy and waveform characteristics are transmitted to the field generators. In response to the transmitted parameters and characteristics, the field generators generate the superimposed set of 3D magnetic fields.

The control parameters may define the position and dynamic requirements of the magnetic field generators, and, when an electromagnet device is used as a field generator, the electrical power and waveform characteristics for each of the field generators in the array that are so configured. The method thereafter includes magnetically shaping the MR material using the superimposed 3D magnetic fields to thereby form a raw 3D shaped component, either in whole or as a set of layers each approximating a two dimensional shape, which may then be cured or otherwise solidified while the superimposed 3D magnetic fields remain active, thereby forming the finished magnetic motor core.

An apparatus or automated system for forming the finished motor core may include a host computer for recording a predetermined 3D geometrical model in a memory location thereof, and an array of magnetic field generators surrounding a staging area and controllable using the host computer. Each of the magnetic field generators in the array has an independently-controllable position and dynamic motion, and is adapted for generating an independently-controllable 3D magnetic field using signals or commands from the host computer.

The host computer uses the 3D geometric model to calculate or derive a solution to an inverse electromagnetic shaping problem translating the complex geometry of the 3D geometrical model into a set of control parameters. The parameters are transmitted to the field generators to thereby generate a superimposed set of 3D magnetic fields suitable for magnetically shaping the volume of MR material into a raw 3D shaped component, either in a series of progressively overlaid and substantially two-dimensional layers or in whole, which in turn can be cured or solidified to form the finished magnetic core.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a motor core being magnetically formed using the method of the present invention; and

FIG. 2 is a schematic flow diagram describing the method of the invention.

### DESCRIPTION OF THE PREFERRED EMBODIMENTS

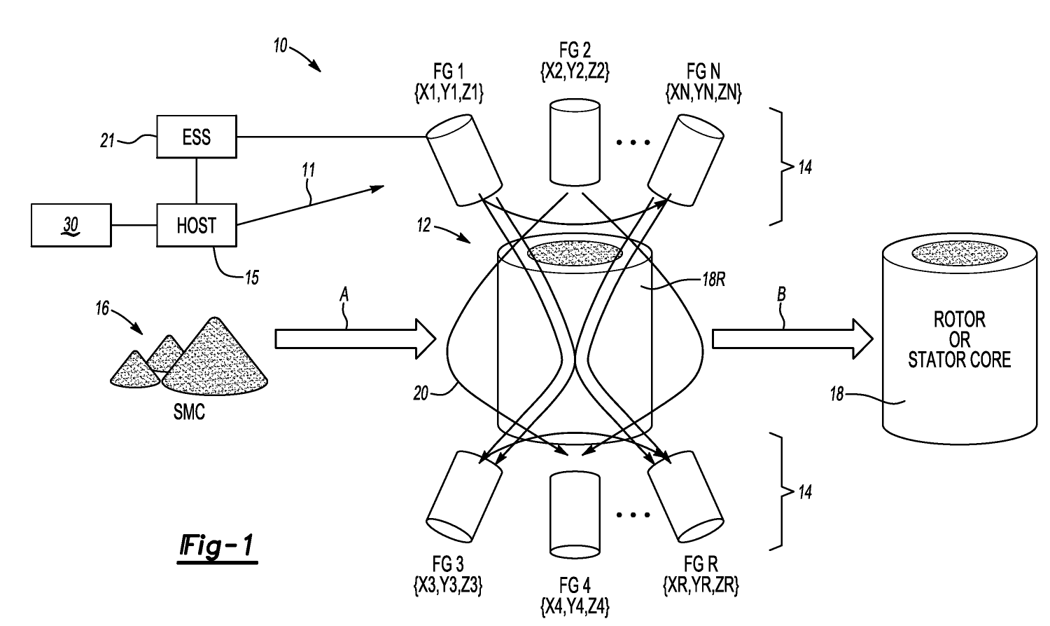

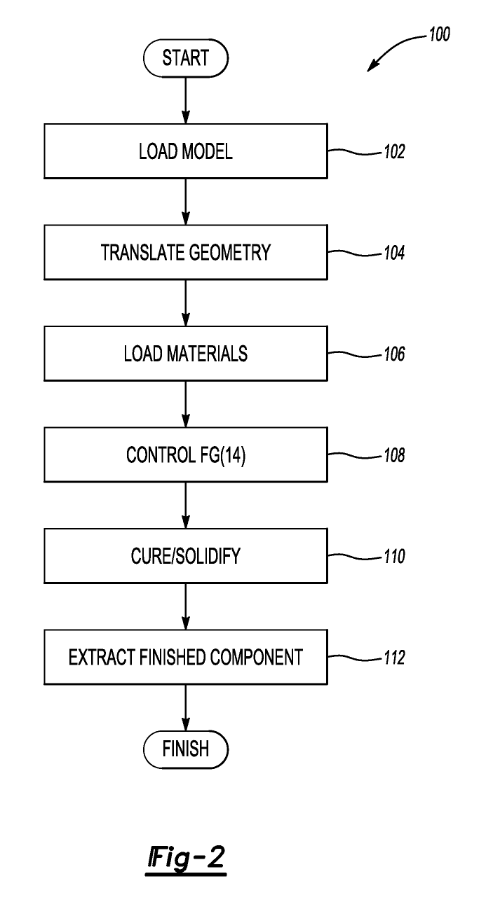

Referring to the drawings, wherein like reference numbers refer to like components, and beginning with FIG. 1, a three-dimensional (3D) shape magnetic forming system 10 includes a staging platform or area 12 surrounded by a set or array of magnetic field generators 14. For clarity, the field generators 14 are labeled in FIG. 1 as FG1, FG2, FG3, FG4, FGN, and FGR. Each field generator 14 is a device adapted for generating a predetermined magnetic field 20 in an x, y, and z direction of a 3D coordinate system. For example, the field generators 14 may be embodied as electromagnetic field coils, straight wires, permanent magnets, charged particles in free space, etc. The number of field generators 14 may vary without departing from the intended scope of the invention, thus the use of the variables N and R. The number of field generators 14 may also be determined based on the particular geometry and/or size of the structure or component being fabricated. Data or information describing a 3D model may be stored in a host computer 15, as explained below with reference to FIG. 2.

Each of the field generators 14 may be electrically connected to an optional energy supply system (ESS) 21, such as a battery, electrical outlet, or other suitable energy source, when the field generators are configured as electromagnetic energized devices. The ESS 21 may be selectively controlled by the host computer 15 over a hard-wired or wireless control link 11 using an algorithm 100 that is resident within or accessible by the host computer 15.

The host computer 15 may be configured as a digital computer having a CPU, and sufficient memory such as read only memory (ROM), random access memory (RAM), electrically-erasable programmable read only memory (EEPROM), etc. The host computer 15 may also include a high-speed clock, analog-to-digital and digital-to-analog circuitry, and input/output circuitry, as well as appropriate signal conditioning and buffer circuitry. Any algorithms resident in the host computer 15 or accessible thereby, including the algorithm 100 described below with reference to FIG. 2, as well as any other required algorithms, may be stored in ROM and automatically executed by the host computer to provide the required functionality.

Soft magnetic composite (SMC) material 16 is fed into the staging area 12 in the direction generally indicated by arrow A. The SMC material 16 may be a magnetorheological (MR) material as described above in powdered or liquid form, or any other easily handled or useable form. While the term MR material is used herein, with a general particle range of approximately 1 micron to approximately 50 micron according to one embodiment, the actual range of particle sizes in the MR material may vary without departing from the intended scope of the invention. That is, ferromagnetic particles on the nanometer scale, such as the type used in ferrofluids, and particles as large as approximately 200 micron, may be used and intermixed as needed to provide the desired shaping and property tuning of the fabricated component.

Epoxy resin or similar material containing a predetermined volume of magnetic particles may be positioned in the staging area 12 within the flux path of the magnetic fields 20 generated by the array of field generators 14. Once positioned, multiple superimposed magnetic fields 20 shape the SMC material 16 into a finished motor core 18 having a complex or 3D geometrical shape. In the embodiment of FIG. 1, the motor core 18 emerging from the staging area in the direction indicated by arrow B is a generally cylindrical rotor or stator core having a desired or tuned set of magnetic properties, although other 3D components may also be fabricated using the method set forth herein.

Referring to FIG. 2, the various steps of the method 100 of the present invention may be programmed in algorithm form and automatically executed by the host computer 15 to shape form magnetic materials into a three-dimensional (3D) magnetic motor core 18 of the type set forth above.

Beginning at step 102, the method 100 includes programming, generating, or otherwise inputting a desired geometric model 30 (see FIG. 1) of the core 18 into and/or using the host computer 15, or using a separate computer device that is accessible thereby. For example, 3D modeling software such as AutoCAD could be resident on or accessible by the host computer 15, with a user utilizing automated modeling tools via such software to generate the desired final 3D shape and any desired or required resultant magnetic properties. Once the model 30 has been generated, the method 100 proceeds to step 104.

At step 104, the host computer 15 translated the modeled geometry from step 102 into required positional and electrical power requirements for shape forming the desired component. For example, step 104 may include calculating or solving an inverse electromagnetic shaping problem or set of equations to translate the modeled geometry from step 102 into the required positional and electrical power requirements. That is, at step 104 a determination is made as to the required mix and amount of MR material, i.e., the SMC 16, the positional and motion control parameters for the field generators 14, and the required magnetic field 20 to be generated by each field generator 14, as well as the required superimposition of each field 20 on the other fields 20.

That is, the position, speed, acceleration, and rotating, linear, and/or oscillating direction of motion of the field generators 14 is calculated or otherwise determined, as well as the frequency, amplitude, or other waveform characteristics needed for the particular shaping. Step 104 may include automatically referencing the model 30 using the host computer 15, or a stored set of lookup tables, formulae, and/or any other required information, to thereby calculate the collective set of control parameters needed for magnetically shaping the core 18. Once determined, the method 100 proceeds to step 106.

At step 106, the SMC 16 may be loaded into the staging area, and may include loading the SMC 16 into a container, device, machine, or other apparatus suitable for holding the SMC 16 within a predetermined envelope or volume. Enclosing the raw SMC 16 within a volume approximating that of the component 18 ultimately being produced is expected to optimize the magnetic shaping capability of the field generators 14 in the array.

In one embodiment, the SMC 16 may be subjected to a preliminary shaping step, such as by lightly or roughly compressing the SMC into a coarse cylindrical shape by pressing and/or hard tooling. Such a step may optimize the subsequent magnetic shaping operation of core 18 by reducing the amount of shaping required by the magnetic fields 20. In another embodiment, the SMC 16 may be shaped in a series of progressive layers similar to the layers used during rapid prototyping or 3D printing. Such layers, although 3D, can have a dimension that is substantially smaller than the other two dimensions, thus forming an approximately 2D shape such as a planar sheet. These layers may be stacked or progressively overlaid to generate the 3D finished component once complete. Each layer may be tuned with respect to its magnetic properties and particle distribution, thus optimizing control of the formation process and the functionality of the finished component. Once loaded, the method 100 proceeds to step 108.

At step 108, the materials or SMC 16 loaded at step 106 are magnetically shaped as explained above, such as by superimposing 3D magnetic fields and exposing the SMC 16 thereto. Precise control of the 3D magnetic fields ultimately shapes the SMC 16 into the core 18. Closed-loop and/or open-loop feedback control may be established as needed with each of the field generators 14 in the magnetic array, with each field generator being independently controlled and operated to optimize the precision of the magnetic shaping process. For closed-loop control, an array of sensors may be used to provide feedback signals from the field generators 14, e.g., position, velocity, acceleration, power level, frequency, wavelength, amplitude, etc., and/or feedback relating to the shape of the raw component 18R, in order to enable precise control over the shaping process. In a closed-loop system, any inverse shaping algorithms from the host computer 15 may be used with the control loop to provide the desired shaping. The method 100 then proceeds to step 110, which may also be executed prior to or concurrently with steps 104 and 106.

At step 110, after the desired 3D shape or geometry has been obtained via magnetic shaping and, optionally, any preliminary pressing or other mechanical shaping of the SMC 16 as explained above at step 108, the raw or unfinished core 18R is held stationary or captive in the staging area 12 within the magnetic fields 20 while the raw core 18R is allowed to cure or otherwise solidify. Step 110 may include any suitable curing or solidifying process, including but not limited to the use of 2-step epoxy curing, chemical curing, and/or heat curing, hardening, or solidification using ovens, laser sintering, or any other compatible and suitable curing or solidifying processes or materials.

As curing and solidifying generally, and heat-based processes in particular, can slowly alter the geometry of the raw core 18R, for example as the raw component shrinks during drying of any fluid content of the MR material originally used in its construction, step 110 may include continuously monitoring the changing geometry of the raw component and modifying the positional and field parameters of the field generators 14 as needed to retain the desired shape. Geometrical variations in the raw core 18R during the curing process therefore may be fully considered at each step to optimize the collective control parameters, such that the finished core 18, such as the exemplary motor core shown in FIG. 2, conforms to the model 30 within a calibrated or allowable dimensional tolerance.

The method 100 concludes with step 112, wherein the supply current to the field generators 14 is terminated if the field generators are electromagnetic in nature, thus terminating the magnetic fields 20, and the core 18 is thereafter removed from the staging area 12. When the field generators 14 are configured as permanent magnets, the core 18 may be directly removed from the staging area 12. At this point, the component 18 may be used for its intended purpose, such as by incorporating the component in an electric motor if it is constructed as a rotor or stator core as shown in the representative embodiment of FIG. 2.

The system 10 of FIG. 1, when used in conjunction with the method 100 as set forth in FIG. 2, may enable smaller and lighter motors than are possible with conventional methods such as laminations, stamping, multi-step welding, etc. The component being formed may be provided with more finely tuned magnetic properties. That is, the ability to vary or alter the magnetic fields during formation may non-uniformly redistribute the magnetic particles before curing or solidifying of the component, allowing tuning or selection of the magnetic properties. Likewise, such tuning is enabled by the greater freedom of control over the static and dynamic properties of the magnetic materials during magnetic shape formation of the component. Tooling costs may be minimized or eliminated relative to conventional methods.

For example, precise control over the 3D magnetic field 20 of FIG. 1 may be used to establish a desired distribution of magnetic particles in the finished core 18. That is, large, small, uniform, or random distributions can be provided for the ferrous or other magnetic particles in the MR material. Likewise, different distributions of magnetic particle materials can be used having different properties, e.g., mixtures of strong permanent magnet material with soft magnetic material, as well as the uniform or random distributions noted above. Viscosity of the MR material in a liquid or pre-bonded phase can be varied, with tuning of the desired properties also being further optimized by varying the curing method at step 110 of FIG. 2. All of the foregoing variations may allow fabrication of the core 18 having optimal performance for its intended purpose.

While the best modes for carrying out the invention have been described in detail, those familiar with the art to which this invention relates will recognize various alternative designs and embodiments for practicing the invention within the scope of the appended claims.

1. A method of forming a magnetic motor core having a predetermined distribution of magnetic particles, the method comprising:
recording a 3D geometrical model of the magnetic motor core using a host computer, the model defining at least a shape of the magnetic motor core and the predetermined distribution of magnetic particles of the magnetic motor core;
using the host computer to generate a set of control parameters using the 3D geometrical model, including deriving a solution to an inverse electromagnetic shaping problem translating the geometry of the 3D geometrical model into the set of control parameters;
generating a plurality of independently-controllable 3D magnetic fields using a corresponding plurality of independently-controllable magnetic field generators;
subjecting a volume of magnetic material to the plurality of independently-controllable 3D magnetic fields; and
shaping the volume of magnetic material into the magnetic motor core having a predetermined distribution of magnetic particles using the independently-controllable 3D magnetic fields;
wherein the magnetic motor core substantially conforms to the 3D geometrical model.

2. The method of claim 1, further comprising solidifying the magnetic motor core while the motor core is subjected to the magnetic fields to thereby permanently retain the shape and the predetermined distribution of magnetic particles.

3. The method of claim 1, wherein shaping the volume of magnetic material into a magnetic motor core includes shaping the volume of magnetic material into one of: a rotor core, a stator core, and a cylindrical portion of a permanent magnet.

4. The method of claim 3, including shaping the volume of magnetic material into one of the rotor core and the stator core, the method further comprising magnetically forming a winding concurrently with one of the rotor core or the stator core.

5. The method of claim 1, further comprising superimposing at least some of the 3D magnetic fields one upon another.

6. The method of claim 1, wherein generating a plurality of independently-controllable 3D magnetic fields includes independently energizing each of a plurality of electromagnetic field coils.

7. A method of forming a magnetic motor core having a predetermined distribution of magnetic particles, the method comprising:
recording a 3D geometrical model of the magnetic motor core in a memory location that is accessible by a host computer, the model defining at least a shape of the magnetic motor core and the predetermined distribution of magnetic particles of the motor core;
using the host computer and the 3D geometrical model to derive a solution to an inverse electromagnetic shaping problem translating the geometry of the 3D geometrical model into a set of control parameters;
positioning a predetermined volume of magnetorheological (MR) material within a staging area surrounded by an array of independently-controllable magnetic field generators;
transmitting the control parameters from the host computer to the magnetic field generators to thereby generate a plurality of 3D magnetic fields, the control parameters defining at least the position and motion required for each of the magnetic field generators to magnetically shape the MR material into the magnetic motor core, wherein the 3D shaped magnetic component substantially conforms to the geometry of the 3D geometrical model; and
magnetically shaping the volume of MR material using the 3D magnetic fields to thereby form the magnetic motor core.

8. The method of claim 7, further comprising solidifying the raw 3D shaped component using at least one of: ultraviolet (UV) curing, chemical curing, laser curing, and heat curing.

9. The method of claim 7, wherein the raw 3D shaped component is one of: a rotor core, a stator core, and a portion of a permanent magnet.

10. The method of claim 7, wherein the finished 3D magnetic component is one of the rotor core and the stator core, the method further comprising: integrally forming a coil or winding onto the rotor core or the stator core concurrently with magnetically shaping the MR material.

11. The method of claim 7, wherein magnetically shaping the volume of MR material includes shaping the material in a series of progressive layers.

12. The method of claim 7, further comprising superimposing at least some of the 3D magnetic fields one upon another.

13. A system for forming a magnetic motor core having a predetermined distribution of magnetic particles, the system comprising:
a host computer adapted for recording a three-dimensional (3D) geometrical model of the motor core in a memory location that is accessible by the host computer, the 3D geometrical model defining at least a shape of the magnetic motor core and the predetermined distribution of magnetic particles in the magnetic motor core; and
an array of magnetic field generators surrounding a staging area containing a volume of magnetic material, wherein each of the magnetic field generators in the array has a position and motion that are controllable using the host computer, and wherein each magnetic field generator is adapted for generating an independently controllable 3D magnetic field;
wherein the host computer is adapted for using the 3D geometric model to derive a set of control parameters, and for transmitting the control parameters to the magnetic field generators to thereby generate a plurality of 3D magnetic fields suitable for magnetically shaping the volume of magnetic material into the magnetic motor core, and wherein the host computer is adapted to derive the set of control parameters by deriving a solution to an inverse electromagnetic shaping problem translating the geometry of the 3D geometrical model into the set of control parameters.

14. The system of claim 13, wherein the magnetic field generators are configured as one of: electromagnetic coils, straight wires, permanent magnets, and charged particles in free space.

15. The system of claim 13, wherein the control parameters are adapted to superimpose at least some of the 3D magnetic fields one upon the other.
